(19) United States
(12) Patent Application Publication
(10) Pub. No.: US 2025/0096635 A1
(43) Pub. Date: Mar. 20, 2025

(54) MOTOR, FAN, AND BEARING DEVICE

(71) Applicant: MINEBEA MITSUMI Inc., Kitasaku-gun (JP)

(72) Inventors: Kouji KEBUKAWA, Kitasaku-gun (JP); Kentaro SUZUKI, Kitasaku-gun (JP); Takayuki YAMASAKI, Kitasaku-gun (JP)

(21) Appl. No.: 18/895,854

(22) Filed: Sep. 25, 2024

Related U.S. Application Data
(63) Continuation-in-part of application No. PCT/JP2023/009916, filed on Mar. 14, 2023.

(30) Foreign Application Priority Data
Mar. 28, 2022 (JP) 2022-052299
Mar. 28, 2022 (JP) 2022-052300

(51) Int. Cl. H02K 5/173; F16C 19/08; H02K 7/08

(52) U.S. Cl. CPC H02K 5/1732; F16C 19/08; H02K 7/083; F16C 2360/46; F16C 2380/26

(57) ABSTRACT

A motor as an example of the present disclosure includes a shaft, a bearing, and a holding member configured to hold the bearing, the holding member includes a protruding part protruding toward the shaft, the bearing and the protruding part are away from each other in the axial direction, and the protruding part and the shaft are away from each other in the radial direction.

### CROSS-REFERENCE TO RELATED APPLICATIONS

This application is a continuation-in-part of International Application No. PCT/JP2023/009916, filed Mar. 14, 2023, and claims the benefit of Japanese Patent Application No. 2022-052299, filed Mar. 28, 2022, and Japanese Patent Application No. 2022-052300, filed Mar. 28, 2022. The contents of these applications are incorporated herein by reference in their entirety.

The present invention relates to a motor, a fan, and a bearing device.

### BACKGROUND

A motor is conventionally used as a drive source of various devices. For example, JP 2009-247143 A discloses a fan motor including a rotor provided with a rotor yoke with a magnet fixed at an inner peripheral side, an impeller disposed at an outer peripheral side of the rotor yoke, and a hub for fixing the impeller.

In this type of fan motor, when the motor rotates, a flow of air may be generated from the outside toward the inside of the motor due to a pressure difference or the like. At this time, minute foreign matter enters together with air through a slight gap formed between the inner ring and the outer ring of a bearing. The foreign matter entering the bearing may deteriorate the bearing.

An issue of the present disclosure is to suppress deterioration of the bearing in the motor.

### SUMMARY

A motor according to the present disclosure includes a shaft, a bearing, and a holding member to hold the bearing, the holding member includes a protruding part protruding toward the shaft, the bearing and the protruding part are away from each other in an axial direction, and the protruding part and the shaft are away from each other in a radial direction.

Further, another motor according to the present disclosure includes a shaft, a weight disposed at one side of the shaft, a first bearing disposed at the one side of the shaft, a second bearing disposed at the other side of the shaft, and an elastic member disposed between the second bearing and the shaft. The first bearing includes an inner ring supported by the shaft, and the weight includes a part at an outer side with respect to the inner ring of the first bearing in a radial direction.

### BRIEF DESCRIPTION OF DRAWINGS

FIG. 1 is a perspective view of a fan including a motor according to a first embodiment being one example of the present disclosure.

FIG. 2 is a cross-sectional view of the fan including the motor according to the first embodiment being one example of the present disclosure, and is a cross-sectional view taken along B-B in FIG. 3.

FIG. 3 is a cross-sectional view of the fan including the motor according to the first embodiment being one example of the present disclosure, and is a cross-sectional view taken along A-A in FIG. 2 (with a coil omitted).

FIG. 4 is a cross-sectional view of a fan including a motor according to a second embodiment being one example of the present disclosure.

FIG. 5 is a cross-sectional view of a fan including a motor according to a third embodiment being one example of the present disclosure.

FIG. 6 is a cross-sectional view of a motor (fan motor) according to a fourth embodiment being another example of the present disclosure.

FIG. 7 is a cross-sectional view illustrating the arrangement of a holding member, a second bearing, and an elastic member in the motor (fan motor) according to the fourth embodiment being another example of the present disclosure.

FIG. 8 is a cross-sectional view of a motor (fan motor) according to a fifth embodiment being another example of the present disclosure.

### DETAILED DESCRIPTION

### First Embodiment

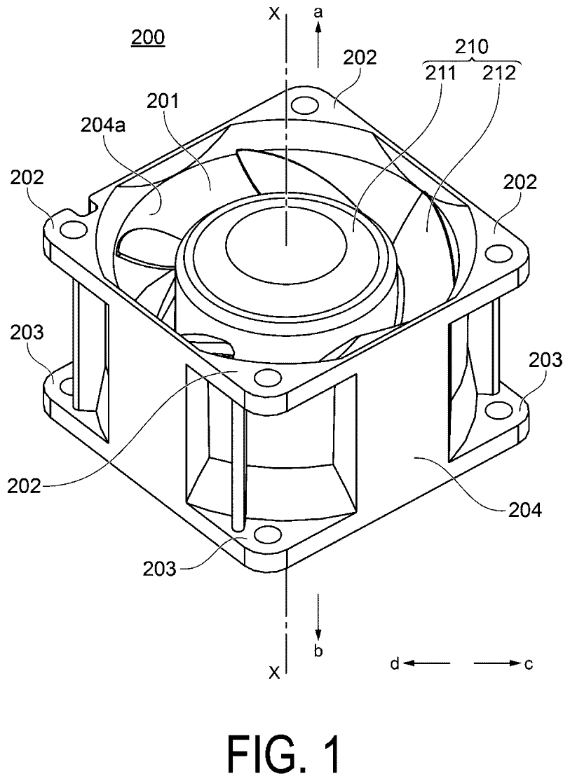

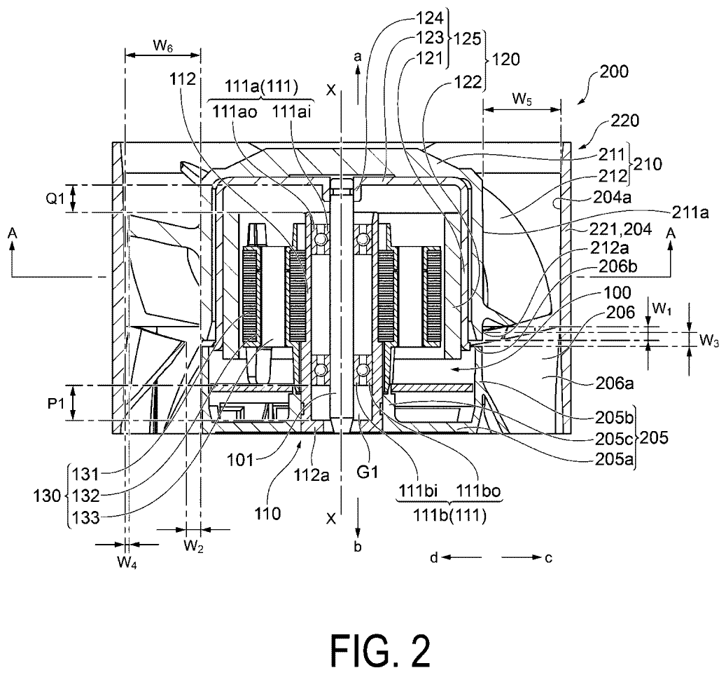

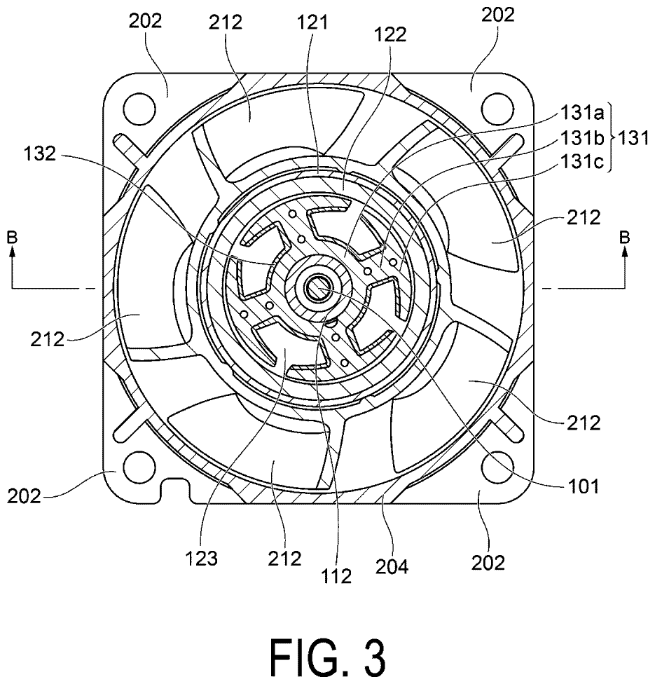

A first embodiment being one example of the present disclosure will be described below with reference to the drawings. FIG. 1 is a perspective view of a fan 200 including a motor 100 according to the present embodiment. FIG. 2 is a cross-sectional view of the fan 200, and is a cross-sectional view taken along B-B in FIG. 3. FIG. 3 is a cross-sectional view of the fan 200, and is a cross-sectional view taken along A-A in FIG. 2 (with a coil 133 omitted).

Note that, in the description of embodiments of the present disclosure, for convenience of description, the direction of an arrow a along an axis X is defined as an upper side or one side. The direction of an arrow b along the axis X is defined as a lower side or the other side. Here, the direction of the arrows a and b is referred to as an up-down direction or an axial direction. However, the up-down direction does not necessarily coincide with a vertical direction. In addition, the direction of arrows c and d is referred to as a radial direction. The direction of the arrow c extending away from the axis X is referred to as an outer side or one side in the radial direction, and the direction of the arrow d extending closer to the axis X is referred to as an inner side or the other side in the radial direction.

The fan 200 according to the present embodiment is a blower to blow air in the axial direction. The fan 200 includes a motor 100, to be described below, and an impeller 210 disposed at one side of a shaft 101, to be described below, of the motor 100. The impeller 210 includes a hub 211 and blades 212, to be described below, and is rotationally driven by the motor 100. As illustrated in FIG. 1, the fan 200 has a tubular shape substantially square in plan view and includes an intake opening 201 for sucking air from an upper side (arrow a direction) in the axial direction into a wind tunnel part having a hollow cylindrical shape.

The fan 200 includes four flange parts 202 at corners at the upper side (arrow a direction) in the axial direction being one side in the axial direction, and four lower flange parts 203 at corners at the lower side (arrow b direction) in the axial direction being the other side in the axial direction. The flange parts 202 and the flange parts 203 are provided with penetrating holes for insertion of a bolt (not illustrated) for attachment to a predetermined apparatus or housing.

The fan 200 includes a side wall 204 surrounding the impeller 210 from the outer side (arrow c direction) in the radial direction being one side in the radial direction, a motor base part 205 formed at an end part at the lower side (arrow b direction) in the axial direction being the other side in the axial direction, and a fixed blade 206 formed with a plurality of stationary blades coupling the side wall 204 and the motor base part 205 in the radial direction (arrow c and d directions) (FIG. 2). Note that, instead of the fixed blades 206 coupling the side wall 204 and the motor base part 205, a plurality of spokes formed with rod-like parts may be used.

The side wall 204, the motor base part 205, and the fixed blade 206 of the fan 200 are integrally formed by injection molding of a synthetic resin such as polybutylene terephthalate reinforced with glass fibers, for example. Note that the side wall 204, the motor base part 205, and the fixed blade 206 of the fan 200 may be formed of other materials.

The side wall 204 defines a wind tunnel part of the fan 200. The side wall 204 has an inner peripheral surface 204a having a cylindrical shape centered on the axis X. The inner peripheral surface 204a has such a diameter that the inner peripheral surface 204a does not come into contact with end parts of the blades 212 of the impeller 210 at the outer side (arrow c direction) in the radial direction. That is, a predetermined gap is formed between the end parts of the blades 212 of the impeller 210 at the outer side (arrow c direction) in the radial direction and the inner peripheral surface of the side wall 204.

The side wall 204 also functions as a guard part to protect the impeller 210. At the corners of the side wall 204 at the upper side (arrow a direction) in the axial direction, the four flange parts 202 are integrally formed with the side wall 204. At the corners of the side wall 204 at the lower side (arrow b direction) in the axial direction, the four flange parts 203 are integrally formed with the side wall 204.

As illustrated in FIG. 2, the motor base part 205 is formed of a base part 205a having a substantially disc shape, an outer peripheral wall 205b having a cylindrical shape extending from an end part of the base part 205a at an outer side in a radial direction toward the upper side (arrow a direction) in the axial direction by a predetermined length, and a boss part 205c having a cylindrical shape projecting from an end part of the base part 205a at the inner side (arrow d direction) in the radial direction, being the other side in the radial direction, toward the upper side (arrow a direction) in the axial direction by a predetermined length.

On a surface of the outer peripheral wall 205b of the motor base part 205 at the outer side in the radial direction, the fixed blade 206 described above is integrally formed in the radial direction. The outer peripheral wall 205b of the motor base part 205 is supported by the side wall 204 of the fan 200 via the fixed blade 206.

The impeller 210 is provided with a hub 211 having a cup shape with a bottom and a cross section substantially in an inverted U-shape and a plurality of blades 212 provided along the circumferential direction at the outer peripheral surface (surface at the outer side in the radial direction) of the hub 211. The hub 211 covers an end part of a shaft 101, to be described below, at the upper side (arrow a direction) in the axial direction to prevent foreign matters from entering from the outside. The plurality of blades 212 all have the same shape and are evenly spaced at equal gaps in the circumferential direction of the hub 211. The hub 211 and the plurality of blades 212 are integrally formed by injection molding of a synthetic resin such as polybutylene terephthalate reinforced with glass fibers, for example.

The hub 211 of the impeller 210 is fixed to the outer peripheral surface (surface at the outer side in the radial direction) of a cylindrical part 121 of a rotor 120, to be described below, and a surface of a lid part 123 of the rotor 120 at the upper side (arrow a direction) in the axial direction. Note that the cylindrical part 121 of the rotor 120 may be inserted into the hub 211 so that the inner peripheral surface (surface at the inner side in the radial direction) of the hub 211 and the outer peripheral surface (surface at the outer side in the radial direction) of the cylindrical part 121 of the rotor 120 are integrally formed.

As illustrated in FIG. 2, the motor 100 includes a shaft 101 and a bearing device 110. The bearing device 110 includes a bearing 111 and a holding member 112 to hold the bearing 111. The holding member 112 is made of metal and has a substantially hollow cylindrical shape as a whole. The holding member 112 is press-fitted to an inner peripheral surface (surface at the inner side in the radial direction) of the boss part 205c of the motor base part 205. Note that the holding member 112 may be formed integrally with the motor base part 205 in a state of being inserted into the boss part 205c.

In the axial direction, the holding member 112 holds a bearing 111a at the upper side (arrow a direction) and holds a bearing 111b at the lower side (arrow b direction). The bearings 111a and 111b are ball bearings. Note that the bearings 111a and 111b are not limited to ball bearings, and various other bearings such as sleeve bearings, for example, may be used. Further, a spring may be provided between the bearings 111a and 111b.

An outer ring 111ao of the bearing 111a and an outer ring 111bo of the bearing 111b are bonded or press-fitted to the inner peripheral surface (surface at the inner side in the radial direction) of the holding member 112. Thus, the outer ring 111ao of the bearing 111a and the outer ring 111bo of the bearing 111b are held by the holding member 112.

An inner ring 111ai of the bearing 111a and an inner ring 111bi of the bearing 111b are bonded or press-fitted to the outer peripheral surface (surface at the outer side in the radial direction) of the shaft 101 having a substantially columnar shape. Thus, the inner ring 111ai of the bearing 111a and the inner ring 111bi of the bearing 111b are fixed to the shaft 101.

The bearing 111a rotatably supports one side (arrow a direction) of the shaft 101 with respect to the holding member 112, and the bearing 111b rotatably supports the other side (arrow b direction) of the shaft 101 with respect to the holding member 112. Thus, the shaft 101 is supported so as to be rotatable relative to the holding member 112.

The holding member 112 has a protruding part 112a having an annular shape protruding toward the shaft 101, that is, toward the inner side (arrow d direction) in the radial direction. In the axial direction, the protruding part 112a is provided at an end part of the holding member 112 at the lower side (arrow b direction). That is, the protruding part 112a is disposed at the other side (arrow b direction) of the shaft 101.

The protruding part 112a is provided at the lower side (arrow b direction) of the bearing 111b in the axial direction. The bearing 111b and the protruding part 112a are away from each other by a distance P1 and oppose each other in the axial direction. Thus, a gap part G1 is formed between the bearing 111b and the protruding part 112a. As a result, the gap part G1 is disposed between the bearing 111b and the protruding part 112a.

Further, the protruding part 112a and the shaft 101 are away from each other and oppose each other in the radial direction. That is, an end part of the protruding part 112a at the inner side in the radial direction is a free end not in contact with other members such as the shaft 101, and there is a space between the end part of the protruding part 112a at the inner side in the radial direction and the shaft 101. The gap part G1 communicates with the outside of the motor through a space between the end part of the protruding part 112a at the inner side in the radial direction and the shaft 101.

In the radial direction, the end part of the protruding part 112a at the inner side in the radial direction is disposed at the inner side (arrow d direction) of the outer ring 111bo of the bearing 111b and at the outer side (arrow c direction) of the inner ring 111bi of the bearing 111b. That is, in the radial direction, the protruding part 112a extends to the inner side (arrow d direction) of the outer ring 111bo of the bearing 111b and to the outer side (arrow c direction) of the inner ring 111bi of the bearing 111b. An inside diameter of the end part of the protruding part 112a at the inner side in the radial direction is smaller than an inside diameter of the outer ring 111bo of the bearing 111b and larger than an outside diameter of the inner ring 111bi of the bearing 111b. However, the protruding part 112a may extend to a position overlapping the inner ring 111bi of the bearing 111b in the radial direction.

The motor 100 is a single-phase brushless DC motor of an outer rotor type and includes a rotor 120 and a stator 130. Note that the motor 100 is not limited to the single-phase brushless DC motor, and may be other motors such as a three-phase brushless DC motor, for example.

The rotor 120 is fixed to one side (arrow a direction) of the shaft 101. The rotor 120 has a rotor yoke 125. The rotor yoke 125 includes a cylindrical part 121 made of a soft magnetic material and disposed coaxially with the shaft 101, a lid part 123 having a substantially disc shape extending toward the inner side (arrow d direction) from an end part at the upper side of the cylindrical part 121 to partially or entirely close the upper side in the axial direction of the cylindrical part 121, and a connecting part 124 having a substantially cylindrical shape projecting to the lower side (arrow b direction) in the axial direction from an end part of the lid part 123 at the inner side in the radial direction by a predetermined length. A magnet 122 having an annular shape is fixed to an inner peripheral surface (surface at the inner side in the radial direction) of the cylindrical part 121 coaxially with the cylindrical part 121. An end part of the connecting part 124 at the lower side (arrow b direction) in the axial direction and an end part of the bearing 111a at the upper side (arrow a direction) in the axial direction are away from each other.

The cylindrical part 121 functions as a part to prevent leakage of the magnetic field of the magnet 122. The shaft 101 is press-fitted and fixed to an inner peripheral surface (surface at the inner side in the radial direction) of the connecting part 124. The cylindrical part 121 and the lid part 123 of the rotor 120 are accommodated in the hub 211 of the impeller 210 and are integrally fixed by an adhesive or the like.

In the axial direction, the lid part 123, and an end part of the holding member 112 at the upper side (arrow a direction) are away from each other by a distance Q1 and oppose each other. In the present embodiment, the distance P1 between the protruding part 112a of the holding member 112 and the bearing 111b is longer in the axial direction than the distance Q1 between the holding member 112 and the rotor 120.

The stator 130 is attached to an outer peripheral surface (surface at the outer side in the radial direction) of the holding member 112. However, the stator 130 may be attached directly to the motor base part 205, not via the holding member 112.

The stator 130 includes a stator core 131 formed by a stacked body with a plurality of cores of an electromagnetic steel plate stacked, the electromagnetic steel plate being made of a soft magnetic material, an insulator 132 made of an insulating material mounted at the stator core 131, and a coil 133 wound around the stator core 131 via the insulator 132. The stator core 131 and the coil 133 are insulated by the insulator 132.

As illustrated in FIG. 3, the stator core 131 includes an annular part 131a, a plurality of tooth parts 131a extending toward the outer side (arrow c direction) in the radial direction from the annular part 131b, and magnetic pole parts 131c as outer peripheral ends of the respective tooth parts 131b. Note that, in FIG. 3, the coil 133 is omitted.

An inner peripheral surface (surface at the inner side in the radial direction) of the annular part 131a of the stator core 131 is fixed to an outer peripheral surface (surface at the outer side in the radial direction) of the holding member 112. Further, the magnetic pole parts 131c of the stator core 131 protrude at both sides in the circumferential direction, and the distance between the adjacent magnetic pole parts 131c in the circumferential direction is shorter than the distance between the adjacent tooth parts 131b.

When the motor 100 is operated and the rotor 120 is rotated together with the shaft 101 by the electromagnetic action between the rotor 120 and the stator 130, the impeller 210 fixed to the rotor 120 is rotated and air is fed toward the lower side (arrow b direction) in the axial direction by the action of the plurality of blades 212. Therefore, the fan 200 functions as a blower.

In the motor 100 according to the present embodiment, the holding member 112 includes the protruding part 112a protruding toward the shaft 101. The bearing 111b and the protruding part 112a are away from each other in the axial direction, and the protruding part 112a and the shaft 101 are away from each other in the radial direction. When the motor 100 rotates, air flows from the outside of the motor 100 into the gap part G1 through the space between the end part of the protruding part 112a at the inner side in the radial direction and the shaft 101 due to a pressure difference between the outside and the inside of the motor 100 or the like. At this time, the protruding part 112a constitutes an obstacle to entry of air, and therefore entry of foreign matter in the air into inside of the bearing device 110 is suppressed.

In addition, a part of the air flowing toward the upper side (arrow a direction) in the axial direction from the space between the end part of the protruding part 112a at the inner side in the radial direction and the shaft 101 collides with the inner ring 111bi of the bearing 111b, and the course of the part of the air is changed toward the outer side (arrow c direction) in the radial direction. Thereafter, the part of the air collides with the inner peripheral surface (surface at the inner side in the radial direction) of the holding member 112, and the course of the part of the air is changed toward the lower side (arrow b direction) in the axial direction. Further thereafter, the part of the air collides with the surface of the protruding part 112a at the upper side (arrow a direction) in the axial direction, and the course of the part of the air is changed toward the inner side (arrow d direction) in the radial direction.

That is, air circulates spirally in the gap part G1. Thus, even if foreign matter enters the gap part G1 together with air, the foreign matter is prevented from entering the bearings 111 by the flow of the circulating air. Therefore, it is possible to suppress deterioration of the bearing 111 and to extend the life of the bearing 111. In addition, heat of the bearing 111 is efficiently dissipated by the circulation of air, and therefore it is possible to further suppress deterioration of the bearing 111 (in particular, the bearing 111b) and to extend the life of the bearing 111.

### Second Embodiment

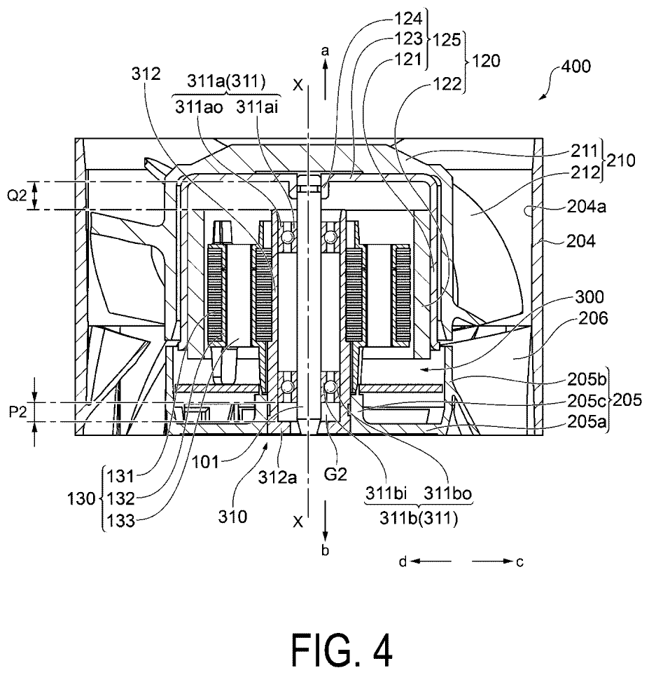

Subsequently, a second embodiment being one example of the present disclosure will be described with reference to the drawings. FIG. 4 is a cross-sectional view of a fan 400 including a motor 300 according to the present embodiment. The fan 400 has a configuration similar to the configuration of the fan 200 according to the first embodiment except that the motor 300 is provided instead of the motor 100. The motor 300 has a configuration similar to the configuration of the motor 100 according to the first embodiment except that a bearing device 310 is provided instead of the bearing device 110. Members and components having the same functions and configurations as the members and components of the first embodiment are given the same reference signs of the first embodiment, and detailed descriptions of the members and components will be omitted below.

As illustrated in FIG. 4, the motor 300 includes a shaft 101 and a bearing device 310. The bearing device 310 includes a bearing 311 and a holding member 312 to hold the bearing 311. The holding member 312 is made of metal and has a substantially hollow cylindrical shape as a whole. The holding member 312 is press-fitted to an inner peripheral surface (surface at the inner side in the radial direction) of the boss part 205c of the motor base part 205. Note that the holding member 312 may be formed integrally with the motor base part 205 in a state of being inserted into the boss part 205c.

In the axial direction, the holding member 312 holds a bearing 311a at the upper side (arrow a direction) and holds a bearing 311b at the lower side (arrow b direction). In the present embodiment, the bearing 311b is held at the lower side (arrow b direction) with respect to the bearing 111b according to the first embodiment. The bearings 311a and 311b are ball bearings. Note that the bearings 311a and 311b are not limited to ball bearings, and various other bearings such as sleeve bearings, for example, may be used. Further, a spring may be provided between the bearings 311a and 311b.

An outer ring 311ao of the bearing 311a and an outer ring 311bo of the bearing 311b are bonded or press-fitted to the inner peripheral surface (surface at the inner side in the radial direction) of the holding member 312. Thus, the outer ring 311ao of the bearing 311a and the outer ring 311bo of the bearing 311b are held by the holding member 312.

An inner ring 311ai of the bearing 311a and an inner ring 311bi of the bearing 311b are bonded or press-fitted to the outer peripheral surface (surface at the outer side in the radial direction) of the shaft 101 having a substantially columnar shape. Thus, the inner ring 311ai of the bearing 311a and the inner ring 311bi of the bearing 311b are fixed to the shaft 101.

The bearing 311a rotatably supports one side (arrow a direction) of the shaft 101 with respect to the holding member 312, and the bearing 311b rotatably supports the other side (arrow b direction) of the shaft 101 with respect to the holding member 312. Thus, the shaft 101 is supported so as to be rotatable relative to the holding member 312.

The holding member 312 has a protruding part 312a having an annular shape protruding toward the shaft 101, that is, toward the inner side (arrow d direction) in the radial direction. In the axial direction, the protruding part 312a is provided at an end part of the holding member 312 at the lower side (arrow b direction). That is, the protruding part 312a is disposed at the other side (arrow b direction) of the shaft 101.

In the axial direction, the protruding part 312a is provided at the lower side (arrow b direction) of the bearing 311b. The bearing 311b and the protruding part 312a are away from each other by a distance P2 and oppose each other in the axial direction. Thus, a gap part G2 is formed between the bearing 311b and the protruding part 312a. As a result, the gap part G2 is disposed between the bearing 311b and the protruding part 312a. In the present embodiment, as described above, the bearing 311b is held at the lower side (arrow b direction) with respect to the bearing 111b according to the first embodiment. Therefore, the distance P2 is shorter than the distance P1 according to the first embodiment.

Further, the protruding part 312a and the shaft 101 are away from each other and oppose each other in the radial direction. That is, an end part of the protruding part 312a at the inner side in the radial direction is a free end not in contact with other members such as the shaft 101, and there is a space between the end part of the protruding part 312a at the inner side in the radial direction and the shaft 101. The gap part G2 communicates with the outside of the motor through a space between the end part of the protruding part 312a at the inner side in the radial direction and the shaft 101.

In the radial direction, the end part of the protruding part 312a at the inner side in the radial direction is disposed at the inner side (arrow d direction) of the outer ring 311bo of the bearing 311b and at the outer side (arrow c direction) of the inner ring 311bi of the bearing 311b. That is, in the radial direction, the protruding part 312a extends to the inner side (arrow d direction) of the outer ring 311bo of the bearing 311b and to the outer side (arrow c direction) of the inner ring 311bi of the bearing 311b. An inside diameter of the end part of the protruding part 312a at the inner side in the radial direction is smaller than an inside diameter of the outer ring 311bo of the bearing 311b and larger than an outside diameter of the inner ring 311bi of the bearing 311b. However, the protruding part 312a may extend to a position overlapping the inner ring 311bi of the bearing 311b in the radial direction.

In the axial direction, the lid part 123 of the rotor 120, and an end part of the holding member 312 at the upper side (arrow a direction) are away from each other by a distance Q2 and oppose each other. The distance Q2 according to the present embodiment is equal to the distance Q1 according to the first embodiment. In the present embodiment, contrary to the first embodiment, the distance P2 between the protruding part 312a of the holding member 312 and the bearing 311b is shorter in the axial direction than the distance Q2 between the holding member 312 and the rotor 120.

In the motor 300 according to the present embodiment, air circulates spirally in the gap part G2 by the same principle as the principle of the motor 100 according to the first embodiment. Therefore, it is possible to suppress deterioration of the bearing 311 and to extend the life of the bearing 311. Further, in the motor 300 according to the present embodiment, the distance P2 is shorter than the distance Q2. Thus, in the motor 300, the air flowing in from the lower side (arrow b direction) in the axial direction of the holding member 312 increases the pressure in the gap part G2, and a further inflow of the air from the lower side (arrow b direction) in the axial direction is suppressed. Therefore, the air easily flows in from the upper side (arrow a direction) in the axial direction of the holding member 312.

The presence of the rotor 120 and the like makes it difficult for foreign matter to enter the upper side in the axial direction of the holding member 312. In addition, the distance Q2 between the holding member 312 and the rotor 120 is long, and therefore most of the air passes across the upper side in the axial direction of the holding member 312 without flowing into inside of the holding member 312. Therefore, in the motor 300 according to the present embodiment, the amount of foreign matter entering the bearing 311 is further reduced, deterioration of the bearing 311 is suppressed, and the life of the bearing 311 can be extended.

### Third Embodiment

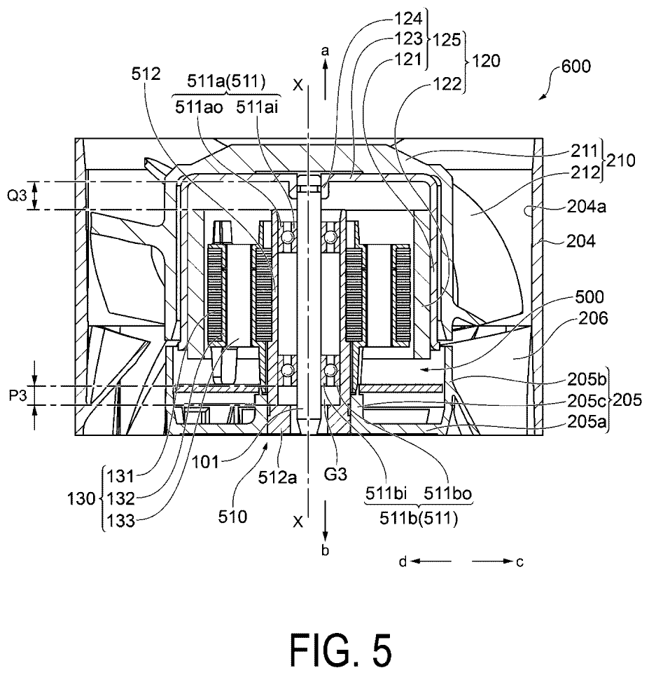

Subsequently, a third embodiment being one example of the present disclosure will be described with reference to the drawings. FIG. 5 is a cross-sectional view of a fan 600 including a motor 500 according to the present embodiment. The fan 600 has a configuration similar to the configuration of the fan 200 according to the first embodiment except that the motor 500 is provided instead of the motor 100. The motor 500 has a configuration similar to the configuration of the motor 100 according to the first embodiment except that a bearing device 510 is provided instead of the bearing device 110. Members and components having the same functions and configurations as the members and components of the first embodiment are given the same reference signs of the first embodiment, and detailed descriptions of the members and components will be omitted below.

As illustrated in FIG. 5, the motor 500 includes a shaft 101 and the bearing device 510. The bearing device 510 includes a bearing 511 and a holding member 512 to hold the bearing 511. The holding member 512 is made of metal and has a substantially hollow cylindrical shape as a whole. The holding member 512 is press-fitted to an inner peripheral surface (surface at the inner side in the radial direction) of the boss part 205c of the motor base part 205. Note that the holding member 512 may be formed integrally with the motor base part 205 in a state of being inserted into the boss part 205c.

In the axial direction, the holding member 512 holds a bearing 511a at the upper side (arrow a direction) and holds a bearing 511b at the lower side (arrow b direction). The bearings 511a and 511b are ball bearings. Note that the bearings 511a and 511b are not limited to ball bearings, and various other bearings such as sleeve bearings, for example, may be used. Further, a spring may be provided between the bearings 511a and 511b.

An outer ring 511ao of the bearing 511a and an outer ring 511bo of the bearing 511b are bonded or press-fitted to the inner peripheral surface (surface at the inner side in the radial direction) of the holding member 512. Thus, the outer ring 511ao of the bearing 511a and the outer ring 511bo of the bearing 511b are held by the holding member 512.

An inner ring 511ai of the bearing 511a and an inner ring 511bi of the bearing 511b are bonded or press-fitted to the outer peripheral surface (surface at the outer side in the radial direction) of the shaft 101 having a substantially columnar shape. Thus, the inner ring 511ai of the bearing 511a and the inner ring 511bi of the bearing 511b are fixed to the shaft 101.

The bearing 511a rotatably supports one side (arrow a direction) of the shaft 101 with respect to the holding member 512, and the bearing 511b rotatably supports the other side (arrow b direction) of the shaft 101 with respect to the holding member 512. Thus, the shaft 101 is supported so as to be rotatable relative to the holding member 512.

The holding member 512 has a protruding part 512a having an annular shape protruding toward the shaft 101, that is, toward the inner side (arrow d direction) in the radial direction. In the axial direction, the protruding part 512a is provided at an end part of the holding member 512 at the lower side (arrow b direction). That is, the protruding part 512a is disposed at the other side (arrow b direction) of the shaft 101.

In the present embodiment, the protruding part 512a is thicker in the axial direction than the protruding part 112a according to the first embodiment. That is, in the present embodiment, a surface of the protruding part 512a at the upper side (arrow a direction) in the axial direction is located at the upper side (arrow a direction) in the axial direction with respect to a surface of the protruding part 112a at the upper side (arrow a direction) in the axial direction according to the first embodiment. Note that, instead of the protruding part 512a being thicker in the axial direction than the protruding part 112a according to the first embodiment, the protruding part 512a may be disposed at the upper side (arrow a direction) in the axial direction with respect to the protruding part 112a according to the first embodiment.

In the axial direction, the protruding part 512a is provided at the lower side (arrow b direction) of the bearing 511b. The bearing 511b and the protruding part 512a are away from each other by a distance P3 and oppose each other in the axial direction. Thus, a gap part G3 is formed between the bearing 511b and the protruding part 512a. As a result, the gap part G3 is disposed between the bearing 511b and the protruding part 512a. As described above, in the present embodiment, a surface of the protruding part 512a at the upper side (arrow a direction) in the axial direction is located at the upper side (arrow a direction) in the axial direction with respect to a surface of the protruding part 112a at the upper side (arrow a direction) in the axial direction according to the first embodiment. Therefore, the distance P3 is shorter than the distance P1 according to the first embodiment.

Further, the protruding part 512a and the shaft 101 are away from each other and oppose each other in the radial direction. That is, an end part of the protruding part 512a at the inner side in the radial direction is a free end not in contact with other members such as the shaft 101, and there is a space between the end part of the protruding part 512a at the inner side in the radial direction and the shaft 101. The gap part G3 communicates with the outside of the motor through a space between the end part of the protruding part 512a at the inner side in the radial direction and the shaft 101.

In the radial direction, the end part of the protruding part 512a at the inner side in the radial direction is disposed at the inner side (arrow d direction) of the outer ring 511bo of the bearing 511b and at the outer side (arrow c direction) of the inner ring 511bi of the bearing 511b. That is, in the radial direction, the protruding part 512a extends to the inner side (arrow d direction) of the outer ring 511bo of the bearing 511b and to the outer side (arrow c direction) of the inner ring 511bi of the bearing 511b. An inside diameter of the end part of the protruding part 512a at the inner side in the radial direction is smaller than an inside diameter of the outer ring 511bo of the bearing 511b and larger than an outside diameter of the inner ring 511bi of the bearing 511b. However, the protruding part 512a may extend to a position overlapping the inner ring 511bi of the bearing 511b in the radial direction.

In the axial direction, the lid part 123 of the rotor 120, and an end part of the holding member 512 at the upper side (arrow a direction) are away from each other by a distance Q3 and oppose each other. The distance Q3 according to the present embodiment is equal to the distance Q1 according to the first embodiment. In the present embodiment, contrary to the first embodiment, the distance P3 between the protruding part 512a of the holding member 512 and the bearing 511b is shorter in the axial direction than the distance Q3 between the holding member 512 and the rotor 120.

In the motor 500 according to the present embodiment, air circulates spirally in the gap part G3 by the same principle as the principle of the motor 100 according to the first embodiment. Therefore, it is possible to suppress deterioration of the bearing 511 and to extend the life of the bearing 511. Further, in the motor 500 according to the present embodiment, the distance P3 is shorter than the distance Q3. Thus, it is possible to suppress deterioration of the bearing 511 and to further extend the life of the bearing 511 by the same principle as the principle of the motor 300 according to the second embodiment.

### Fourth Embodiment

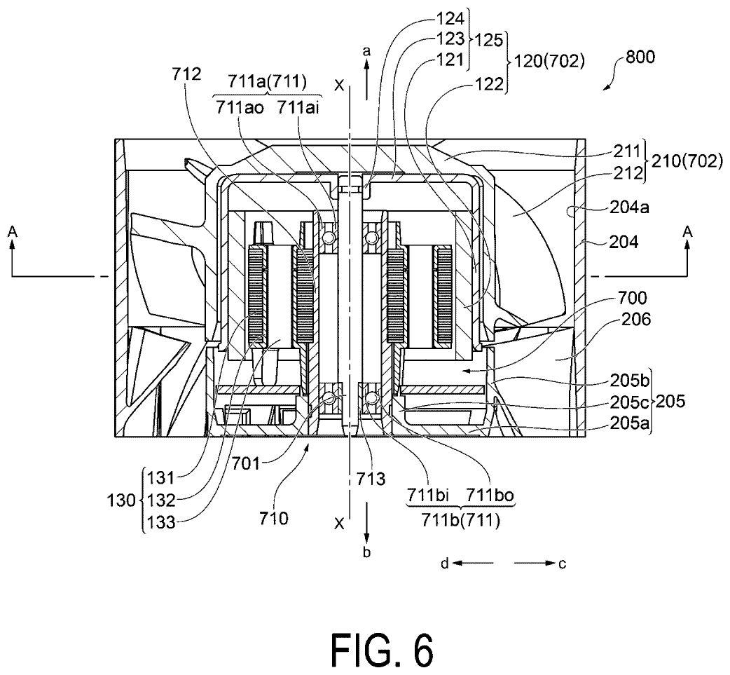

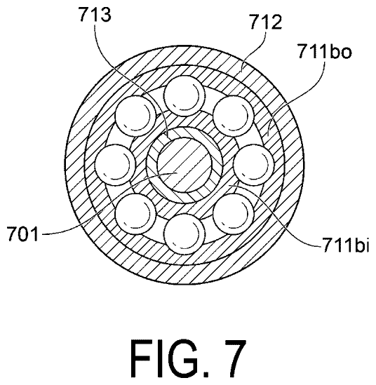

A fourth embodiment being another example of the present disclosure will be described below with reference to the drawings. FIG. 6 is a cross-sectional view of a motor (fan motor 800) according to the present embodiment. FIG. 7 is a cross-sectional view illustrating the arrangement of a holding member 712, a second bearing 711b, and an elastic member 713 in the fan motor 800 according to the present embodiment. The fan motor 800 has a configuration similar to the configuration of the fan 200 according to the first embodiment except that a motor body 700 is provided instead of the motor 100. The motor body 700 has a configuration similar to the configuration of the motor 100 according to the first embodiment except that a bearing device 710 is provided instead of the bearing device 110 and a shaft 701 is provided instead of the shaft 101. Members and components having the same functions and configurations as the members and components of the first embodiment are given the same reference signs of the first embodiment, and detailed descriptions of the members and components will be omitted below.

As illustrated in FIG. 6, the motor body 700 includes the shaft 701, weights (a rotor 120 and an impeller 210) 702 disposed at one side (arrow a direction) of the shaft 701, and the bearing device 710. The bearing device 710 includes the bearing 711, the holding member 712 to hold the bearing 711, and the elastic member 713. The holding member 712 is made of metal and has a substantially hollow cylindrical shape as a whole. The holding member 712 is press-fitted to an inner peripheral surface (surface at the inner side in the radial direction) of the boss part 205c of the motor base part 205. Note that the holding member 712 may be formed integrally with the motor base part 205 in a state of being inserted into the boss part 205c.

In the axial direction, the holding member 712 holds a first bearing 711a at the upper side (arrow a direction) and holds a second bearing 711b at the lower side (arrow b direction). The first bearing 711a and the second bearing 711b are ball bearings. Note that the first bearing 711a and the second bearing 711b are not limited to ball bearings, and various other bearings such as sleeve bearings, for example, may be used.

An outer ring 711ao of the first bearing 711a and an outer ring 711bo of the second bearing 711b are bonded or press-fitted to the inner peripheral surface (surface at the inner side in the radial direction) of the holding member 712. Thus, the outer ring 711ao of the first bearing 711a and the outer ring 711bo of the second bearing 711b are held by the holding member 712.

An inner ring 711ai of the first bearing 711a is bonded or press-fitted to the outer peripheral surface (surface at the outer side in the radial direction) of the shaft 701 having a substantially columnar shape. Thus, the inner ring 711ai of the first bearing 711a is supported by the shaft 701. No member (except for an adhesive) is interposed between the first bearing 711a and the shaft 701, and the first bearing 711a and the shaft 701 are in direct contact with each other in the radial direction. However, the term “in direct contact” as used herein includes a mode of contacting via an adhesive. On the other hand, the elastic member 713 having a cylindrical shape is disposed between the second bearing 711b (inner ring 711bi) and the shaft 701. The inner ring 711bi of the second bearing 711b is press-fitted to the outer peripheral surface (surface at the outer side in the radial direction) of the shaft 701 via the elastic member 713. In this way, the inner ring 711bi of the second bearing 711b is supported by the shaft 701 via the elastic member 713.

The shaft 701 has a smaller diameter at a location of the second bearing 711b being disposed and a part at the lower side (arrow b direction) in the axial direction than at a part at the upper side (arrow a direction) in the axial direction. Thus, the second bearing 711b having the same size and configuration as the first bearing 711a can be disposed via the elastic member 713. In the second bearing 711b, as illustrated in FIG. 7, the shaft 701, the elastic member 713, the inner ring 711bi, the balls, the outer ring 711bo, and the holding member 712 are disposed in this order from the inner side in the radial direction.

The elastic member 713 is a cylindrical member having elasticity. In the axial direction, the elastic member 713 has the same or substantially the same height as the height of the second bearing 711b. Examples of the material to form the elastic member 713 include thermosetting elastomers such as natural rubber and synthetic rubber, and thermoplastic elastomers such as styrene-based, olefin-based, vinyl chloride-based, acryl-based, polyamide-based, polyester-based, and polyurethane-based elastomers.

The first bearing 711a is disposed at one side (arrow a direction) of the shaft 701 and rotatably supports the one side (arrow a direction) of the shaft 701 with respect to the holding member 712. The second bearing 711b is disposed at the other side (arrow b direction) of the shaft 701 and rotatably supports the other side (arrow b direction) of the shaft 701 with respect to the holding member 712. Thus, the shaft 701 is supported so as to be rotatable relative to the holding member 712.

The motor body 700 is a single-phase brushless DC motor of an outer rotor type and includes a rotor 120 and a stator 130. Note that the motor body 700 is not limited to the single-phase brushless DC motor, and may be other motors such as a three-phase brushless DC motor, for example. The rotor 120 is one of the weights 702 in the fan motor 800.

The rotor 120 is fixed to one side (arrow a direction) of the shaft 701. The rotor 120 has a rotor yoke 125. The rotor yoke 125 includes a cylindrical part 121 made of a soft magnetic material and disposed coaxially with the shaft 701, a lid part 123 having a substantially disc shape extending toward the inner side (arrow d direction) from an end part at the upper side of the cylindrical part 121 to partially or entirely close the upper side in the axial direction of the cylindrical part 121, and a connecting part 124 having a substantially cylindrical shape projecting to the lower side (arrow b direction) in the axial direction from an end part of the lid part 123 at the inner side in the radial direction by a predetermined length. A magnet 122 having an annular shape is fixed to an inner peripheral surface (surface at the inner side in the radial direction) of the cylindrical part 121 coaxially with the cylindrical part 121. An end part of the connecting part 124 at the lower side (arrow b direction) in the axial direction and an end part of the first bearing 711a at the upper side (arrow a direction) in the axial direction are away from each other.

The cylindrical part 121 functions as a part to prevent leakage of the magnetic field of the magnet 122. The shaft 701 is press-fitted and fixed to an inner peripheral surface (surface at the inner side in the radial direction) of the connecting part 124. The cylindrical part 121 and the lid part 123 of the rotor 120 are accommodated in the hub 211 of the impeller 210 and are integrally fixed by an adhesive or the like. In the axial direction, the lid part 123 and an end part of the holding member 712 at the upper side (arrow a direction) are away from each other by a predetermined distance and oppose each other.

When the fan motor 800 is operated and the rotor 120 is rotated together with the shaft 701 by the electromagnetic action between the rotor 120 and the stator 130, the impeller 210 fixed to the rotor 120 is rotated and air is fed toward the lower side (arrow b direction) in the axial direction by the action of the plurality of blades 212. Therefore, the fan motor 800 functions as a blower.

Each of the rotor 120 and the impeller 210 can be regarded as a member constituting the weight 702 in the fan motor 800. In the radial direction, the weight 702 has a part at the outer side (arrow c direction) with respect to the inner ring 711ai of the first bearing 711a. The weight 702 has an arm part extending to the outer side (arrow c direction) in the radial direction, and the arm part extends to the outer side (arrow c direction) in the radial direction with respect to the inner ring 711ai of the first bearing 711a. In the axial direction, an end part at the other side of the weight 702 is disposed at the other side (arrow b direction) with respect to the first bearing 711a.

When the rotor 120 is regarded as one member constituting the weight 702 in the fan motor 800, a part of the rotor 120 corresponding to a part of the weight 702 at the outer side with respect to the inner ring 711ai of the first bearing 711a includes a part of the lid part 123, the cylindrical part 121, and the magnet 122. A part of the rotor 120 corresponding to the arm part of the weight 702 is the lid part 123. A part of the rotor 120 corresponding to an end part at the other side of the weight 702 is end parts of the cylindrical part 121 and the magnet 122 at the lower side (arrow b direction).

Further, when the impeller 210 is regarded as one member constituting the weight 702 in the fan motor 800, a part of the impeller 210 corresponding to a part of the weight 702 at the outer side with respect to the inner ring 711ai of the first bearing 711a includes a part of the hub 211 and the blades 212. A part of the impeller 210 corresponding to the arm part of the weight 702 is the hub 211. A part of the impeller 210 corresponding to an end part at the other side of the weight 702 includes end parts of the blades 212 and the hub 211 at the lower side (in the arrow b direction).

When a load member (weight) such as an impeller is disposed at one side of a shaft of a motor including two bearings disposed at the shaft, the bearing at the side closer to the weight may deteriorate as the motor is used, and a gap may be formed between the inner ring and the shaft. If the motor continues to be used in this state, the bearing at the side far from the weight may be damaged first, and then the motor may be deteriorated.

In the fan motor 800 according to the present embodiment, the rotor 120 and the impeller 210 serving as the weights 702 are disposed at one side of the shaft 701. In the radial direction, the rotor 120 and the impeller 210 include a part at the outer side with respect to the inner ring 711ai of the first bearing 711a, and in the axial direction, end parts of the rotor 120 and the impeller 210 at the other side are disposed at the other side (arrow b direction) with respect to the first bearing 711a. Therefore, when the fan motor 800 is operated, a large load is applied to the first bearing 711a.

However, the elastic member 713 can absorb a radial load applied to the second bearing 711b by the swinging rotation of the shaft 701, even when the fan motor 800 is used for a long period of time and a gap is formed between the inner ring 711ai of the first bearing 711a and the shaft 701. Therefore, the load on the second bearing 711b is reduced, and damage to the second 711b is prevented. As a result, damage to the first bearing 711a is also prevented. Thus, deterioration of the fan motor 800 is suppressed and the life of the fan motor 800 is extended.

### Fifth Embodiment

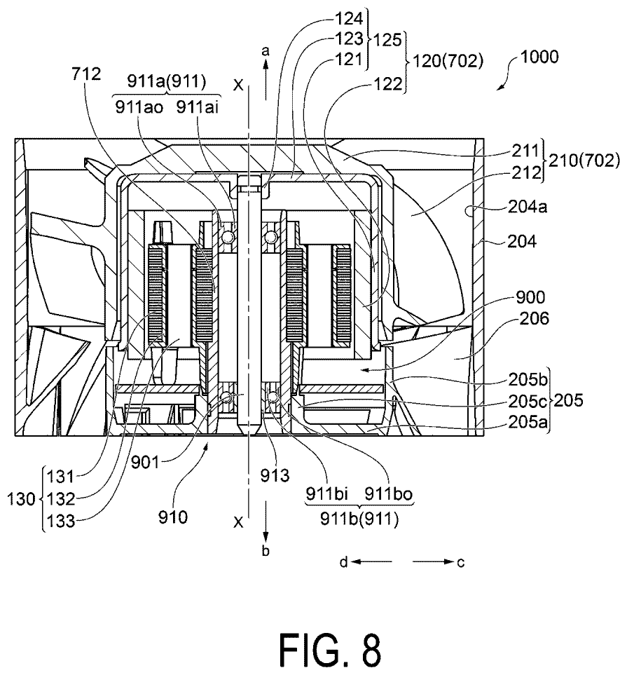

Subsequently, a fifth embodiment being another example of the present disclosure will be described with reference to the drawings. FIG. 8 is a cross-sectional view of a fan motor 1000 according to the present embodiment. The fan motor 1000 has a configuration similar to the configuration of the fan motor 800 according to the fourth embodiment except that a motor body 900 is provided instead of the motor body 700. The motor body 900 has a configuration similar to the configuration of the motor body 700 according to the fourth embodiment except that a bearing device 910 is provided instead of the bearing device 710 and a shaft 901 is provided instead of the shaft 701. Members and components having the same functions and configurations as the members and components of the fourth embodiment are given the same reference signs of the fourth embodiment, and detailed descriptions of the members and components will be omitted below.

As illustrated in FIG. 8, the motor body 900 includes the shaft 901, weights (a rotor 120 and an impeller 210) 702 disposed at one side (arrow a direction) of the shaft 901, and the bearing device 910. The bearing device 910 includes a bearing 911, a holding member 712 to hold the bearing 911, and an elastic member 913.

In the axial direction, the holding member 712 holds a first bearing 911a at the upper side (arrow a direction) and holds a second bearing 911b at the lower side (arrow b direction). The first bearing 911a and the second bearing 911b are ball bearings. Note that the first bearing 911a and the second bearing 911b are not limited to ball bearings, and various other bearings such as sleeve bearings, for example, may be used.

An outer ring 911ao of the first bearing 911a and an outer ring 911bo of the second bearing 911b are bonded or press-fitted to the inner peripheral surface (surface at the inner side in the radial direction) of the holding member 712. Thus, the outer ring 911ao of the first bearing 911a and the outer ring 911bo of the second bearing 911b are held by the holding member 712.

An inner ring 911ai of the first bearing 911a is bonded or press-fitted to the outer peripheral surface (surface at the outer side in the radial direction) of the shaft 901 having a substantially columnar shape. Thus, the inner ring 911ai of the first bearing 911a is supported by the shaft 901. No member (except for an adhesive) is interposed between the first bearing 911a and the shaft 901, and the first bearing 911a and the shaft 901 are in direct contact with each other in the radial direction. However, the term “in direct contact” as used herein includes a mode of contacting via an adhesive. On the other hand, the elastic member 913 having a cylindrical shape is disposed between the second bearing 911b (inner ring 911bi) and the shaft 901. The inner ring 911bi of the second bearing 911b is press-fitted to the outer peripheral surface (surface at the outer side in the radial direction) of the shaft 901, having a substantially columnar shape, via the elastic member 913. In this way, the inner ring 911bi of the second bearing 911b is supported by the shaft 901 via the elastic member 913.

Unlike the shaft 701 according to the fourth embodiment, the diameter of the shaft 901 at a location of the second bearing 911b being disposed and a part at the lower side (arrow b direction) in the axial direction is equal to the diameter of a part at the upper side (arrow a direction) in the axial direction. The diameter of the shaft 901 is unchanged and equal from a location of the first bearing 911a being disposed to the location of the second bearing 911b being disposed.

In the present embodiment, the outside diameter of the second bearing 911b is equal to the outside diameter of the first bearing 911a, while the inside diameter of the second bearing 911b is larger than the inside diameter of the first bearing 911a. Thus, the second bearing 911b can be disposed at the shaft 901 via the elastic member 913.

The elastic member 913 is a cylindrical member having elasticity. In the axial direction, the elastic member 913 has the same or substantially the same height as the height of the second bearing 911b. Examples of the material to form the elastic member 913 include thermosetting elastomers such as natural rubber and synthetic rubber, and thermoplastic elastomers such as styrene-based, olefin-based, vinyl chloride-based, acryl-based, polyamide-based, polyester-based, and polyurethane-based elastomers.

The first bearing 911a is disposed at one side (arrow a direction) of the shaft 901 and rotatably supports the one side (arrow a direction) of the shaft 901 with respect to the holding member 712. The second bearing 911b is disposed at the other side (arrow b direction) of the shaft 901 and rotatably supports the other side (arrow b direction) of the shaft 901 with respect to the holding member 712. Thus, the shaft 901 is supported so as to be rotatable relative to the holding member 712.

In the fan motor 1000 according to the present embodiment as well, the elastic member 913 can absorb a radial load applied to the second bearing 911b by the swinging rotation of shaft 901. Therefore, the load on the second bearing 911b is reduced, and damage to the second 911b is prevented. As a result, damage to the first bearing 911a is also prevented. Thus, deterioration of the fan motor 1000 is suppressed and the life of the fan motor 1000 is extended.

While the motor, fan, and bearing device according to the present disclosure have been described above with reference to preferred embodiments, the motor, fan, and bearing device according to the present disclosure are not limited to the configuration of the embodiments described above. For example, in the above-described embodiment, the motor 100, 300, 500 is used for the fan 200, 400, 600, respectively. However, the motor according to the present disclosure may not be used for the fan.

In the above-described embodiment, the motor 100, 300, 500 and the fan motor 800, 1000 are motors of an outer rotor type. However, the motors according to the present disclosure may be motors of an inner rotor type. In this case, the weight may be any member disposed at one side of the shaft and including a part at the outer side with respect to the inner ring of the first bearing.

In the above-described embodiment, the motor 100, 300, 500 has two bearings. However, the motor according to the present disclosure may have only one bearing or three or more bearings.

In the above-described embodiment, the protruding part 112a, 312a, 512a of the holding member 112, 312, 512 has an annular shape. However, in the motor according to the present disclosure, the shape of the protruding part of the holding member is not limited to an annular shape and may be any shape.

In the above-described embodiment, the protruding part 112a, 312a, 512a extends to the inner side (arrow d direction) in the radial direction with respect to the outer ring 111bo, 311bo, 511bo of the bearing 111b, 311b, 511b. However, in the motor according to the present disclosure, in the radial direction, the protruding part may not extend to the inner side with respect to the outer ring of the bearing but may extend to a position overlapping the outer ring of the bearing.

In addition, a person skilled in the art can appropriately modify the motor, fan, and bearing device according to the present disclosure and change the combinations of the various configurations according to previously known knowledge. Note that such modifications are of course included in the scope of the present disclosure as long as these modifications still include the configurations of the present disclosure.

For example, the present disclosure may include the following configurations. As illustrated in FIG. 2, the impeller 210 includes an outer peripheral surface 211a of a hub 211 and a plurality of blades 212 provided at the outer peripheral surface of the hub 211. The fixed blade 206 includes a plurality of stationary blades including a first stationary blade 206a. In the radial direction, a part of the first stationary blade 206a of the fixed blade 206 opposes a part of the outer peripheral surface 211a of the hub 211.

In the axial direction, a part of the first stationary blade 206a of the fixed blade 206 (a part opposing the outer peripheral surface 211a of the hub 211 in the radial direction) has a first size W₁. In the radial direction, a gap having a second size W₂ is formed between a part of the first stationary blade 206a of the fixed blade 206 (a part opposing the outer peripheral surface 211a of the hub 211 in the radial direction) and a part of the outer peripheral surface 211a of the hub 211. In the axial direction, a lower end part 212a of the first blade 212 of the impeller 210 and an upper end part 206b of the first stationary blade 206a of the fixed blade 206 oppose each other. In the axial direction, a gap having a third size W₃ is formed between the lower end part 212a of the first blade 212 of the impeller 210 and the upper end part 206b of the first stationary blade 206a of the fixed blade 206. The second size W₂ and the third size W₃ may be smaller than the first size W₁.

Further, a housing 220 includes a tube 221. The tube 221 includes flange parts 203 and a side wall 204. A gap having a fourth size W₄ is formed between the impeller 210 and the tube 221 of the housing 220. The second size W₂ and the third size W₃ may be larger than the fourth size W₄.

In the radial direction, a gap having a fifth size W₅ is formed between the outer peripheral surface 211a of the hub 211 and the tube 221 of the housing 220. In the radial direction, a gap having a sixth size W₆ is formed between the outer peripheral wall 205b of the base part 205a and the tube 221 of the housing 220. The sixth size W₆ may be smaller than the fifth size W₅.

1. A motor comprising:
a shaft;
a bearing; and
a holding member configured to hold the bearing, wherein
the holding member includes a protruding part protruding toward the shaft,
the bearing and the protruding part are away from each other in an axial direction, and
the protruding part and the shaft are away from each other in a radial direction.

2. The motor according to claim 1, wherein
a gap part is disposed between the bearing and the protruding part in the axial direction, and
the gap part communicates with an outside of the motor through a space between an end part of the protruding part at an inner side in the radial direction and the shaft.

3. The motor according to claim 1, comprising
a rotor, wherein
in the axial direction, the rotor is fixed at one side of the shaft, and the protruding part is disposed at the other side of the shaft.

4. The motor according to claim 3, wherein a distance between the protruding part and the bearing is shorter than a distance between the holding member and the rotor in the axial direction.

5. The motor according to claim 1, wherein
the bearing includes an outer ring held by the holding member, and
the end part of the protruding part at the inner side in the radial direction is disposed at an inner side with respect to the outer ring in the radial direction.

6. A fan comprising:
the motor according to claim 1; and
an impeller disposed at one side of the shaft.

7. A bearing device comprising:
a bearing; and
a holding member configured to hold the bearing, wherein
the holding member includes a protruding part protruding toward an inner side in a radial direction,
the bearing and the protruding part are away from each other in an axial direction, and
an end part of the protruding part at the inner side in the radial direction is a free end.

8. A motor comprising:
a shaft;
a weight disposed at one side of the shaft;
a first bearing disposed at the one side of the shaft;
a second bearing disposed at the other side of the shaft; and
an elastic member disposed between the second bearing and the shaft, wherein
the first bearing includes an inner ring supported by the shaft, and
the weight includes a part at an outer side with respect to the inner ring of the first bearing in a radial direction.

9. The motor according to claim 8, wherein
the weight includes an arm part extending to an outer side in the radial direction, and
the arm part extends to the outer side in the radial direction with respect to the inner ring of the first bearing.

10. The motor according to claim 8, wherein the first bearing is a ball bearing.

11. The motor according to claim 8, wherein the second bearing includes an inner ring supported by the shaft, and the elastic member is disposed between the inner ring and the shaft.

12. The motor according to claim 8, wherein in an axial direction, an end part at the other side of the weight is disposed at the other side with respect to the first bearing.

13. The motor according to claim 8, wherein the first bearing is in direct contact with the shaft in the radial direction.

14. The motor according to claim 8, wherein the weight is a rotor.

15. The motor according to claim 8, wherein: the motor is a fan motor including an impeller, and
the weight is the impeller.
